(19) United States
(12) Patent Application Publication
(10) Pub. No.: US 2010/0310430 A1
(43) Pub. Date: Dec. 9, 2010

(54) BARRIER FOR AN ACID ALKYLATION UNIT AND PROCESS RELATING THERETO

(76) Inventor: Keith W. Hovis, Stillwater, OK (US)

Correspondence Address: HONEYWELL/UOP;PATENT SERVICES, 101 COLUMBIA DRIVE, P O BOX 2245 MAIL STOP AB/2B, MORRISTOWN, NJ, 07962, US

(21) Appl. No.: 12/478,302

(22) Filed: Jun. 4, 2009

(51) Int. Cl. B01J 19/00; F16J 15/02

(52) U.S. Cl. 422/129; 422/310; 277/312

(57) ABSTRACT

One exemplary embodiment can be a barrier for a leak escaping from an alkylation unit. The barrier can include a plurality of members positioned proximate to at least one surface of a vessel in the alkylation unit. Generally, the plurality of members includes at least one first member spaced apart from the at least one surface, and at least one second member distinct from the at least one first member spaced apart from the at least one surface. Typically, the second member has at least a portion closer to the at least one surface than the at least one first member.

### FIELD OF THE INVENTION

This invention generally relates to a barrier that can slow an escaping leak or pressurized stream to minimize the vaporization of, e.g., at least one component of an acid alkylation catalyst.

### DESCRIPTION OF THE RELATED ART

Often an acid alkylation catalyst is utilized in alkylation processes. One difficulty of using an acid catalyst is that vessels and piping containing the alkylation catalyst can corrode and leak. Typically, a pressurized release of an alkylation catalyst can allow at least a portion to vaporize and escape to the atmosphere. Particularly, the risk of vaporization can be higher with a high pressure fluid escaping through a small orifice with a high exit velocity, as compared to a lower pressure release through a large orifice with a low exit velocity.

Generally, it is preferable that the alkylation catalyst remains in a liquid state and falls to the pad underneath the equipment. Often, an agent is included with the alkylation catalyst to prevent its vaporization, so the fluid can pool on the pad as a liquid. This phenomenon of condensing of the leaked fluid and pooling on the pad is generally referred to as “rainout”. Unfortunately, during a pressurized release, the alkylation catalyst can still at least partially vaporize despite the presence of an agent to prevent this outcome.

A containment baffle can be used to trap the released alkylation catalyst. However, the barrier can trap heavier-than-air isoparaffins that can be present with the alkylation catalyst. As such, the isoparaffins trapped in the baffle can increase the risk of explosion. Moreover, the use of a secondary containment device can increase the pressure of the trapped gas. The pressure may result in hydrogen blistering of the vessel walls, and again, create an explosion risk. Thus, containment baffles and secondary containment devices can create other hazards in an attempt to contain the unplanned release of the alkylation catalyst. As a consequence, there is a desire to provide a system for minimizing vaporization of a released alkylation catalyst without the associated risks of explosion.

### SUMMARY OF THE INVENTION

One exemplary embodiment can be a barrier for a leak escaping from an alkylation unit. The barrier can include a plurality of members positioned proximate to at least one surface of a vessel in the alkylation unit. Generally, the plurality of members includes at least one first member spaced apart from the at least one surface, and at least one second member distinct from the at least one first member spaced apart from the at least one surface. Typically, the second member has at least a portion closer to the at least one surface than the at least one first member.

Another exemplary embodiment may be an acid alkylation unit. The acid alkylation unit may include at least one vessel containing an acid alkylation catalyst. Typically, a plurality of members is positioned proximate to at least one surface of the at least one vessel in the acid alkylation unit. The plurality of members can include at least one first member spaced apart from the at least one surface, and at least one second member distinct from the at least one first member and spaced apart from the at least one surface. Usually, the at least one second member has at least a portion closer to the at least one surface than the at least one first member.

Yet another exemplary embodiment may be a process for providing a barrier to a pressurized stream escaping from an acid alkylation vessel. The process can include providing first and second members proximate to at least one surface of a vessel. Usually, the second member has at least a portion closer to the at least one surface of the vessel than the first member to slow the escaping pressurized stream to minimize the vaporization of a hydrogen fluoride.

In the embodiments disclosed herein, a barrier can limit the vaporization of an alkylation catalyst and a volatility reducing agent in air. As a result, the alkylation catalyst vaporization rate can be minimized by reducing the time that the released mixture can entrain in the air. Often, the alkylation catalyst and volatility reducing agent can be in mixture with light hydrocarbons that may vaporize upon release into the atmosphere. To reduce the risk of an explosion, the embodiments herein can provide a geometry with overlapping opposite barriers on, e.g., circular-shaped vessels and pipings to create, e.g., a barrier or fence. The barrier can block the jet release of liquid that may impinge on the barrier. The gas or vapor may freely escape, and the barrier should not significantly increase wind loadings of the vessels and pipings. Moreover, these types of barriers can be retrofitted on existing vessels and piping.

### DEFINITIONS

As used herein, the term “stream” can be a stream including various hydrocarbon molecules, such as straight-chain, branched, or cyclic alkanes, alkenes, alkadienes, and alkynes, and optionally other substances, such as gases, e.g., hydrogen, or impurities, such as heavy metals, and sulfur and nitrogen compounds. The stream can also include aromatic and non-aromatic hydrocarbons. Moreover, the hydrocarbon molecules may be abbreviated C1, C2, C3 . . . Cn where “n” represents the number of carbon atoms in the one or more hydrocarbon molecules.

As used herein, the term “zone” can refer to an area including one or more equipment items and/or one or more sub-zones. Equipment items can include one or more reactors or reactor vessels, heaters, exchangers, pipes, pumps, compressors, and controllers. Additionally, an equipment item, such as a reactor, dryer, or vessel, can further include one or more zones or sub-zones.

As used herein, the term “vessel” can mean a drum, a settler, a reactor, one or more pipes or lines, at least one or more components of a heat exchanger, such as a shell or one more tubes, and any other equipment that at least partially contains a fluid including an alkylation catalyst.

As used herein, the term “rich” can mean an amount of at least generally about 30%, preferably about 50%, and optimally about 70%, by weight, of a compound or class of compounds in a stream or an effluent.

As used herein, the term “substantially” can mean an amount of at least generally about 80%, preferably about 90%, and optimally about 99%, by weight, of a compound or class of compounds in a stream or an effluent.

As used herein, the term “vapor” can mean at least one of a gas or a dispersion that may include or consist of one or more hydrocarbons.

As used herein, the term “hydrogen fluoride” can include at least one of a hydrogen fluoride or a hydrofluoric acid. Generally, a hydrofluoric acid is a solution of a hydrogen fluoride in water, where the hydrogen fluoride can disassociate and may form ions of H₃O⁺, H⁺, FHF⁻, and F⁻.

As used herein, the term “distinct” can mean a first member that is not directly connected or formed integrally together with a second member so that the first member and the second member may appear as separate pieces. However, these pieces may be indirectly connected together by being separately coupled to, e.g., a vessel.

As used herein, the term “coupled” can mean two items, directly or indirectly, joined, fastened, associated, connected, or formed integrally together either by chemical or mechanical means, by processes including stamping, molding, or welding. What is more, two items can be coupled by the use of a third component such as a mechanical fastener, e.g. a screw, a nail, a staple, or a rivet; an adhesive; or a solder.

As used herein, the term “member” can mean an object of any suitable shape such as a plate, a prism, or a mesh.

As depicted, process flow lines in the figures can be referred to as lines, pipes, effluents, or streams. Particularly, a line or pipe can contain one or more effluents or streams, and one or more effluents and streams can be contained by a line or pipe. Also, the terms “line” and “pipe” may be used interchangeably.

### BRIEF DESCRIPTION OF THE DRAWINGS

FIG. 1 is a schematic depiction of an exemplary alkylation unit.

FIG. 2 is a schematic top, plan view of an exemplary barrier.

FIG. 3 is a schematic cross-sectional view along line 3-3 in FIG. 2.

FIG. 4 is a schematic top, plan view of another exemplary barrier.

FIG. 5 is a schematic cross-sectional view along line 5-5 of FIG. 4.

FIG. 6 is a graphical depiction of the percent of HF rain-out capture with respect to barrier distance.

### DETAILED DESCRIPTION

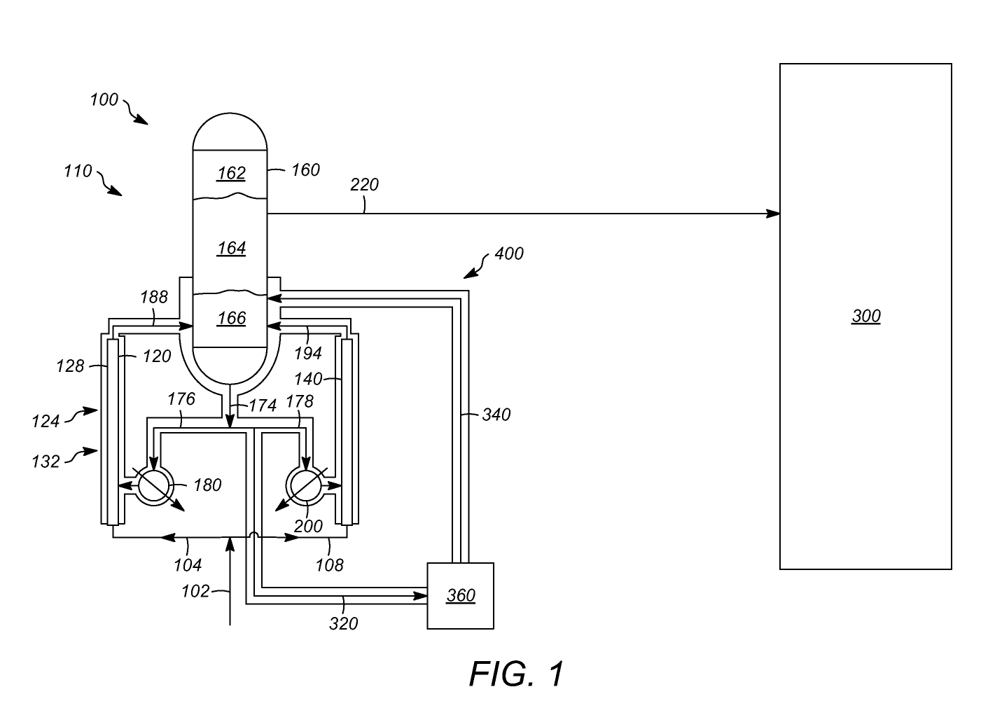

Referring to FIGS. 1-3, an alkylation unit 100, typically an acid alkylation unit 100, can include at least one vessel 110 and a fractionation zone 300. In this exemplary alkylation unit 100, the at least one vessel 110 can include a first alkylation reactor 120, a second alkylation reactor 140, a settler 160, a fractionation zone 300, and a barrier 400. Although the first and second alkylation reactors 120 and 140 are riser reactors receiving an alkylation catalyst from the settler 160 via gravity, it should be understood that other alkylation reactors can be utilized, such as a cooler reactor receiving alkylation catalyst via a fluid transfer device, such as a pump, from a settler. Exemplary alkylation units are disclosed in, e.g., U.S. Pat. No. 5,098,668.

Usually, the alkylation reaction can include the reaction of an isoparaffin, such as isobutane, with an olefin or other alkylating agent such as propylene, isobutylene, butene-1, butenes-2, and amylenes. Generally, the reaction of an isoparaffin with a C3 or a C4 olefin, such as isobutylene, butene-1, and/or butenes-2, is an example of a preferred reaction involving these specified materials and mixture. Usually, the stream rich in isobutane can at least be partially provided by recycling isobutane from the downstream fractionation zone 300 and include make-up isobutane from one or more other refinery or chemical manufacturing units.

Typically, the alkylation catalyst can include a hydrogen fluoride, a sulfuric acid, a phosphoric acid, a metal halide, or other suitable alkylation catalyst. Preferably, the catalyst is a hydrogen fluoride. Generally, the alkylation reaction is carried out with substantial molar excess of isoparaffin:olefin, typically in excess of about 1:1, preferably about 4:1-about 70:1, optimally about 5:1-about 20:1. Usually, the system or unit 100 can maintain an alkylation catalyst:hydrocarbon volume ratio of about 1:1-about 5:1.

The system or unit 100 may be operated with a volatility reducing agent to improve safety margins in the event of an uncontrolled acid release. The volatility reducing agents normally contemplated are those that may reduce the volatility of the acid alkylation catalyst. The agent may include at least one of an organic sulfone, such as 3-methylsulfolane, 2,4-dimethylsulfolane, and tetramethylenesulfone, which may also be referred to as sulfolane, an ammonia, an amine, such as a lower alkylamine (e.g., methyl to pentyl), a pyridine, an alkylpyridine, a picoline, a melamine, and a hexmethylenetetramine. Exemplary volatility reducing agents are disclosed, in, e.g., US 2008/0177123 A1.

Generally, a hydrocarbon feed including an alkylation catalyst, one or more isoparaffins and one or more olefins is provided via a line 102. The hydrocarbon feed 102 can be split in a pipe 104 to the first alkylation reactor 120 and a pipe 108 to the second alkylation reactor 140. The first and second alkylation reactors 120 and 140 can be substantially similar, such that they can have the same shape. The reaction effluent from the first alkylation reactor 120 and the second alkylation reactor 140 can pass through respective lines 188 and 194 to the settler 160. In the settler 160, the products can separate into a vapor phase 162, a hydrocarbon phase 164, and an acid phase 166. The acid phase 166 can pass through a pipe outlet 174 to a pipe 176 to a first exchanger 180 and a pipe 178 to a second exchanger 200. Typically, the first and second exchangers 180 and 200 are used to cool the alkylation catalyst before it is received in, respectively, the first alkylation reactor 120 and the second alkylation reactor 140. Also, a slipstream can be withdrawn via a line 320 and provided to an alkylation catalyst regeneration zone 360. Afterwards, a regenerated catalyst can be returned via a line 340 to any suitable location, such as the settler 160 or in a line upstream of the alkylation reactor 120 or 140.

The hydrocarbon phase 164 can pass through a line 220 to the fractionation zone 300. In the fractionation zone 300, several products can be obtained, such as propane, isobutane, and n-butane. Generally, at least a portion of the isobutane or other isoparaffin can be recycled back to the first and second alkylation reactors 120 and 140. Exemplary distillation columns of the fractionation zone 300 may be disclosed in, e.g., U.S. Pat. No. 3,931,352 and U.S. Pat. No. 3,972,956.

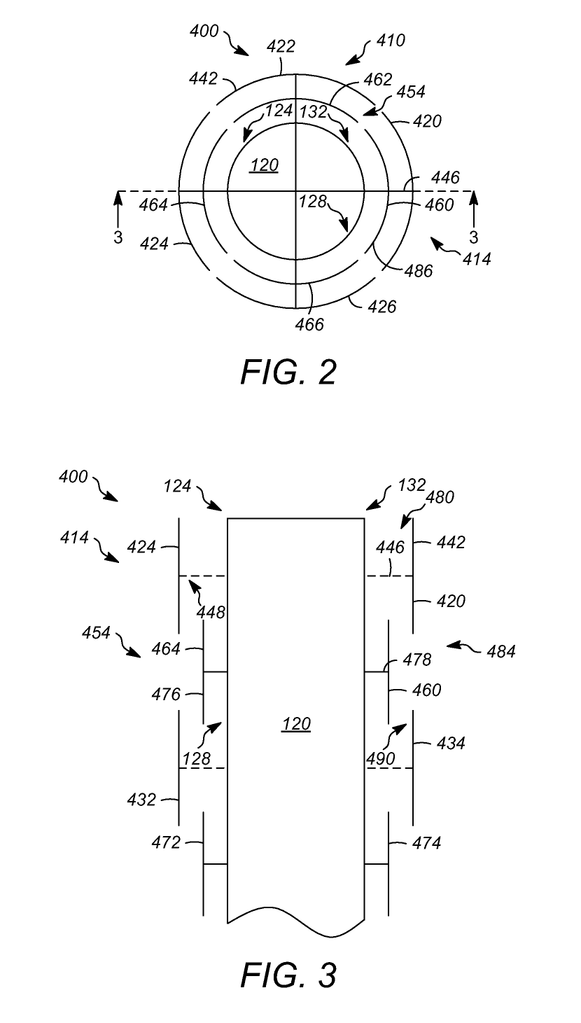

Referring to FIGS. 2-3, one exemplary embodiment of a barrier 400 can include a plurality of members 410. In this exemplary embodiment, the first alkylation reactor 120 can have a substantially cylindrical shape 124 having at least one surface 128 forming a periphery 132. The plurality of members 410 can be arranged to contour the periphery 132 in substantially concentric circular forms. Although in this exemplary embodiment, the first alkylation reactor 120 is substantially cylindrical in shape, it should be understood that other shapes of the first alkylation reactor 120 or other vessels 110 may be used, and the plurality of members 410 can similarly be contoured to that shape. Moreover, the barrier 400 is suitable to be contoured to any suitable vessel 110.

The plurality of members 410 can include at least one first member 414 spaced apart from the at least one surface 128 and at least one second member 454 spaced apart from the at least one surface 128. The at least one first member 414 can include six members 420, 422, 424, 426, 432 and 434, although any suitable number or plurality of members may be utilized. Generally, at least one member 414 can form a substantially first tube 442 spaced apart from the surface 128. Several of these tubes 442 may be formed and spaced along the length of the first alkylation reactor 120. Generally, each of the members in this exemplary embodiment are substantially identical, so only the member 420 will be described in detail, although in other embodiments each member can vary in shape and/or size.

A first support 446 can couple the first member 420 to the first alkylation reactor 120. Generally, the first support 446 can form at least one aperture 448 for allowing liquid that escapes from the first alkylation reactor 120 to drain. Other first supports can couple respective first members to the first alkylation reactor 120.

The at least one second member 454 can include six second members 460, 462, 464, 466, 472, and 474, although any suitable number or plurality of members may be utilized. Generally, at least a portion 476 of the at least one second member 454 is closer to the surface 128 than at least one first member 414. A second support 478 can couple the second member 460 to the first alkylation reactor 120. In addition, similar second supports can couple other members to the surface 128. Although this second support 478 does not form apertures for draining liquid, this support and optionally the other second supports can also form apertures for draining liquid.

Generally, at least one first member 414 forms a substantially first pervious tube 442 spaced apart from the surface outside the at least one second member 454 forming a substantially second pervious tube 486, usually concentric pervious tubes 442 and 486 as viewed from FIG. 2. Typically, each of the members of the first and second members 414 and 454 are offset 480 with one another with at least one first member 414 overlapping a portion 484 of at least one second member 454 with respect to the surface 128. As such, a passage 490 can be formed by the first tube 442 and the second tube 486 for a leak escaping from the first alkylation reactor 120. This passage 490 can slow the leak to prevent the vaporization of the stream and allow the liquid to fall to the pad below.

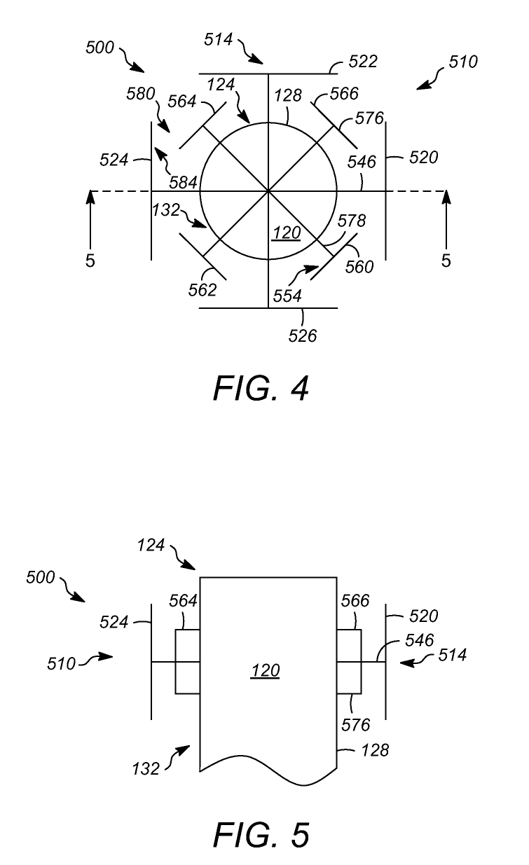

Referring to FIGS. 4-5, another exemplary embodiment of a barrier 500 is depicted. Generally, the barrier 500 can include a plurality of members 510, such as at least one first member 514 and at least one second member 554. Each of the plurality of members 510 can be any suitable shape, such as a plate, prism, or mesh, and desirably have a size so as not to create excessive wind resistance. Particularly, each of the plurality of members 510 can either be square or rectangular in shape, although any suitable shape may be used, such as an oval, a circle, or a hexagon. Alternatively, a single member or members collectively can form any suitable shape, such as a polygon, e.g., a square, surrounding the periphery 128.

Generally, the at least one first member 514 and at least one second member 554 are spaced apart from the at least one surface 128 of the first alkylation reactor 120. The at least one first member 514 can include four members 520, 522, 524, and 526, but any suitable number of members may be utilized. In this exemplary embodiment, groups of four members can be arranged along the length of the first alkylation reactor 120. Referring to member 520, generally a first support 546 can couple the first member 520 to the surface 128 of the first alkylation reactor 120. Similarly, other first supports can couple other first members to the at least one surface 128.

The at least one second member 554 can include four second members 560, 562, 564, and 566. Although four members are disclosed, it should be understood that any suitable number or plurality of members can be used. A second support 578 can couple the member 560 to the at least one surface 128 of the first alkylation reactor 120. Similarly, other second supports can couple other second members to the at least one surface 128.

Generally, at least a portion 576 of at least one second member 554 is closer to the surface than the at least one first member 514. Generally, each of the members 514 and 554 are skewed or in a tangent relation with respect to the at least one surface 128. Particularly, each of the plurality of members 510, if positioned adjacent to the at least one surface 128, may touch the surface 128 at a single point. Although the periphery 132 of the first alkylation reactor 120 is substantially circular, it should be understood that any suitable shape can be utilized and the at least one first member 514 and the at least one second member 554 can be skewed with respect to that periphery 132. Moreover, the plurality of members 510 can be constructed as a barrier 500 for any suitable vessel 110.

Usually, the at least one first member 514 and at least one second member 554 are offset 580 from each other to create a barrier 500 around the first alkylation reactor 120. Preferably, at least one first member 514 overlaps a portion 584 of at least one second member 554 to intercept an escaping leak or pressurized stream with respect to the surface 128. Hence, a stream escaping from the first alkylation reactor 120 can impact, and thus slow its velocity to prevent the vaporization of the leaked material.

Generally, the barriers 400 and 500 can be made from any suitable material, such as carbon steel, stainless steel, titanium, or plastic. Generally, the members 410 and 510 can have any suitable shape, and can be in the form of a mesh, such as a mesh demister. Generally, the length of the members 410 and 510 can be anywhere from about 1-about 100 centimeter (hereinafter may be abbreviated “cm”) in length. Preferably, the members can have a length of about 2 cm-about 1 meter (hereinafter may be abbreviated “m”), preferably about 10 cm-about 20 cm.

The size of the members 410 and 510 can be effective to minimize wind shear. Generally, the members 410 and 510 and supports can be coupled to a vessel using any suitable means, such as welds, bolts, rivets, or other mechanical fasteners. Alternatively, the members 410 and 510 can be releasably clamped to the surface 128. In some embodiments, at least some of the members 410 and 510 can couple directly to the surface 128. Moreover, the barriers 400 and 500 can be retrofitted to existing vessels.

### Illustrative Embodiments

Experiments are conducted to measure the effects of pressure and distance on the capture of an alkylation catalyst. In these examples, the alkylation catalyst is hydrogen fluoride. Referring to Table 1, data depicts an impact pad located about 1 m. The tested compositions included hydrogen fluoride (may hereinafter be abbreviated “HF”), a volatility reducing agent such as sulfolane (may hereinafter may be abbreviated “AG”), and water. The presence of an impact pad can limit the distance the jet travels before it hits the ground.

TABLE 1

| | Composition | | | | Impact | | |
|---|---|---|---|---|---|---|---|
| | of | | | Orifice | Pad | H₂O | HF |
| Example | HF/AG/water | Pressure | Temperature | Diameter | Distance | In | Rainout |
| No. | (Wt. %) | (kPa) | (° C.) | (cm) | (m) | Pans | (Wt. %) |
| 1 | 69/29/02 | 1,070 | 32 | 1 | 1 | Yes | 90 |
| 2 | 69/29/02 | 1,650 | 32 | 1 | 1 | Yes | 89 |

Any differences in the composition condensation or rainout can be due to differences in drop size and residence time. Because the release speed is proportional to the square root of the pressure, the residence time for a 1,650 kPa jet is about 0.8 times that of a 1,070 kPa jet. The specific surface area for droplet evaporation can be inversely proportional to the droplet diameter. Because the composition evaporation is proportional to the product of the specific surface area and the residence time, it appears that increasing the pressure from 1,070 kPa to 1,650 kPa, the drop size is also decreased to about 0.8 of its size at 1,070 kPa. The drop size can vary inversely only as the square root of the pressure. As such, there is an insignificant change in the drop size of the jetted composition. Although not wanting to be bound by theory, pressure does not significantly impact the drop size. For unimpeded jets, there can be more alkylation catalyst evaporation from the drops at the higher pressure release because the high pressure jet travels farther before it hits the ground. So, the residence time appears to be the more significant factor as opposed to pressure of the composition and subsequent droplet size for determining percentage of the jetted composition raining to the pad.

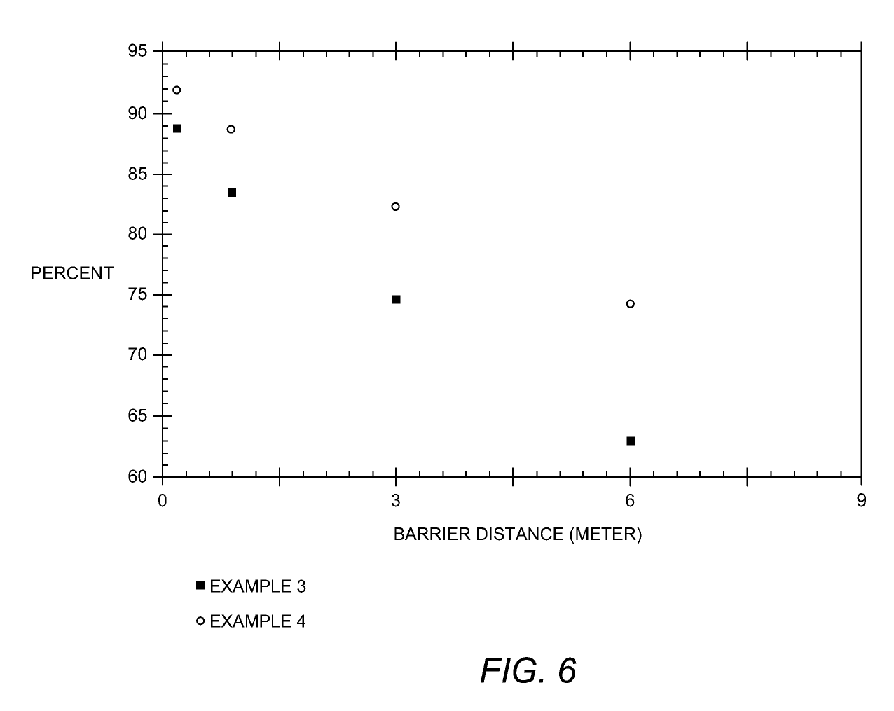

Two exemplary compositions (Examples 3 and 4) are compared with barriers placed at 0.3, 1, 3, and 6 meters. The jetted compositions are at a pressure of 1,650 kPa and a temperature of 32° C., and include 70%, by weight, hydrogen fluoride. The compositions are jetted through a circular orifice 1 cm in diameter. Example 3 is a mixture of hydrogen fluoride and water, and Example 4 is a mixture of hydrogen fluoride, a volatility reducing agent, and water. Referring to FIG. 6, this figure depicts the effective barrier distance on the composition capture. The capture decreases rapidly with increasing barrier distance whether or not a volatility reducing agent is included. Although not wanting to be bound by theory, the further the barrier from the orifice increases the jet length, and hence, the air entrained by the jet. Increased air entrainment can create a greater driving force for the hydrogen fluoride to evaporate from the droplets. Also, the residence time for the drops to evaporate increases with increasing barrier distance.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing, all temperatures are set forth in degrees Celsius and, all parts and percentages are by weight, unless otherwise indicated.

From the foregoing description, one skilled in the art can easily ascertain the essential characteristics of this invention and, without departing from the spirit and scope thereof, can make various changes and modifications of the invention to adapt it to various usages and conditions.

1. A barrier for a leak escaping from an alkylation unit, comprising:
A) a plurality of members positioned proximate to at least one surface of a vessel in the alkylation unit; wherein the plurality of members comprises:
1) at least one first member spaced apart from the at least one surface; and
2) at least one second member distinct from the at least one first member spaced apart from the at least one surface wherein the second member has at least a portion closer to the at least one surface than the at least one first member.

2. The barrier according to claim 1, wherein the plurality of members, independently, is contoured to the at least one surface of the vessel.

3. The barrier according to claim 1, wherein the vessel comprises an alkylation reactor, a pipe, an exchanger, or a settler.

4. The barrier according to claim 1, wherein the vessel has a substantially cylindrical shape.

5. The barrier according to claim 4, wherein the at least one first member comprises a plurality of first members forming substantially a first tube spaced apart from the at least one surface.

6. The barrier according to claim 5, wherein the at least one second member forms a second tube positioned inside the first tube and spaced apart from the at least one surface.

7. The barrier according to claim 1, wherein a support couples the at least one first member to the at least one surface.

8. The barrier according to claim 7, wherein the support forms at least one aperture for draining liquid accumulating on the support.

9. The barrier according to claim 1, wherein the at least one first member is skewed with respect to the at least one surface of the vessel.

10. The barrier according to claim 9, wherein the at least one second member is skewed with respect to the at least one surface of the vessel.

11. The barrier according to claim 1, wherein a support couples the at least one second member to the at least one surface of the vessel.

12. The barrier according to claim 1, wherein each of the first and second members comprises a plate.

13. The barrier according to claim 1, wherein the at least one first member and the at least one second member are offset with respect to a periphery of the at least one surface.

14. The barrier according to claim 13, wherein the at least one first member overlaps a portion of the at least one second member with respect to the at least one surface.

15. The barrier according to claim 6, wherein the first and second tubes form a passage for the leak escaping from the vessel and the first tube overlaps at least a portion of the second tube with respect to the at least one surface.

16. An acid alkylation unit, comprising:
A) at least one vessel containing an acid alkylation catalyst, wherein:
1) a plurality of members is positioned proximate to at least one surface of the at least one vessel in the acid alkylation unit; wherein the plurality of members comprises:
a) at least one first member spaced apart from the at least one surface; and
b) at least one second member distinct from the at least one first member and spaced apart from the at least one surface wherein the at least one second member has at least a portion closer to the at least one surface than the at least one first member.

17. A process for providing a barrier to a pressurized stream escaping from an acid alkylation vessel, comprising:
A) providing first and second members proximate to at least one surface of a vessel wherein the second member has at least a portion closer to the at least one surface of the vessel than the first member to slow the escaping pressurized stream to minimize the vaporization of a hydrogen fluoride.

18. The process according to claim 17, wherein the vessel comprises an acid settler.

19. The process according to claim 17, wherein the vessel comprises an acid alkylation reactor.

20. The process according to claim 17, wherein the vessel comprises one or more pipes communicating an acid settler with an acid alkylation reactor.
